(19) United States
(12) Patent Application Publication
(10) Pub. No.: US 2007/0298846 A1
(43) Pub. Date: Dec. 27, 2007

(54) Wireless power transmission

(75) Inventors: Charles E. Greene, Cabot, PA (US); Daniel W. Harrist, Carnegie, PA (US)

Correspondence Address: Ansel M. Schwartz;Attorney at Law, Suite 304, 201 N. Craig Street, Pittsburgh, PA, 15213, US

(73) Assignee: Powercast, LLC

(21) Appl. No.: 11/811,081

(22) Filed: Jun. 8, 2007

Related U.S. Application Data
(60) Provisional application No. 60/813,540, filed on Jun. 14, 2006.

(51) Int. Cl. H04B 1/04; H04B 1/16

(52) U.S. Cl. 455/572; 455/127.1; 455/343.1

(57) ABSTRACT

Disclosed is a system for power transmission. The system includes a receiver having a receiver antenna. An RF power transmitter includes a transmitter antenna. The RF power transmitter transmits RF power. The RF power includes multiple polarization components. The receiver converts the RF power to direct current. Also disclosed is an antenna for an RF power transmission system. The antenna includes at least two antenna elements. Alternating the radiation between the at least two antenna elements produces a power transmission having components in two polarizations. Additionally disclosed is a transmitter, a receiver and a method for power transmission.

### BACKGROUND OF THE INVENTION

1. Field of the Invention

The present invention is directed to a wireless power transmission system including a radio frequency (RF) power transmitter and a receiver and, more specifically, an RF power transmission system including wave components in multiple polarizations.

2. Description of Related Art

As processor capabilities have expanded and power requirements have decreased, there has been an ongoing explosion of devices that operate completely independent of wires or power cords. These “untethered” devices range from cell phones and wireless keyboards to building sensors and active Radio Frequency Identification (RFID) tags.

Engineers and designers of these untethered devices continue to have to deal with the limitations of portable power sources, primarily using batteries as the key design parameter. While the performance of processors and portable devices has been doubling every 18-24 months (driven by Moore's law), battery technology in terms of capacity has only been growing at 6% per year.

Even with power conscious designs and the latest in battery technology, many devices do not meet the lifetime cost and maintenance requirements for applications that require a large number of untethered devices, such as logistics and building automation. Today's devices that need two-way communication require scheduled maintenance every three to 18 months to replace or recharge the device's power source (typically a battery). One-way devices that simply broadcast their status without receiving any signals, such as automated utility meter readers, have a better battery life typically requiring replacement within 10 years. For both device types, scheduled power-source maintenance is costly and can be disruptive to the entire system that a device is intended to monitor and/or control. Unscheduled maintenance trips are even more costly and disruptive. On a macro level, the relatively high cost associated with the internal battery also reduces the practical, or economically viable, number of devices that can be deployed.

The ideal solution to the power problem for untethered devices is a device or system that can collect and harness sufficient energy from the environment. The harnessed energy would then either directly power an untethered device or augment a power supply. However, this ideal solution may not always be practical to implement due to low energy in the environment and site restrictions that limit the ability to use a dedicated energy supply.

A need exists for a solution that takes these factors into account and provides for the ideal situation and for more restrictive circumstances.

It is known to power a device through the use of radio frequency (RF) waves. However, problems arise when the device to be powered is not always positioned to receive the transmitted RF from the RF power transmitter. Given a linear RF power transmitter and a linear receiver that converts RF power to direct current (DC) power, the polarizations of the antennas are critical for the receiver to receive the desired RF from the RF power transmitter. If the polarity of the antenna within the receiver changes from the designed optimum, then the throughput of the system deteriorates.

For example, if the RF power transmitter is positioned to be stationary during use of the system and the receiver is not stationary (mobile), the receiver may not always receive optimum power from the RF power transmitter. The amount of power received would be dependent on where the receiver is positioned with respect to the RF power transmitter.

The same is true when the RF power transmitter is mobile and the receiver is stationary. The same is also true when the RF power transmitter and the receiver are both mobile.

For another example, if the RF power transmitter is positioned to be stationary during use and the system includes more than one receiver positioned to be stationary during use, only receivers optimally positioned to receive the power will receive the optimum power. The remaining receivers will not receive the optimum power.

In a power transmission system, there are two sources of loss due to antenna positioning: polarization and gain. The polarization of an antenna is the polarization of the wave radiated by the antenna in a given direction. In a two antenna system (transmitting and receiving), polarization loss occurs when one antenna is mismatched in polarization with respect to the other antenna. Gain loss occurs when one antenna is out of orientation with respect to the other antenna, which occurs when the directions of maximum gain for each antenna do not fall on a line and point at each other.

The amount of power from the transmitter to the receiver may be estimated using the Friis equation.

As used throughout, a linearly polarized antenna may be a dipole, monopole, folded dipole, patch, yagi, sleeve dipole, loop, horn, dish, corner reflector, or any other linearly polarized antenna. As used throughout, an elliptically, circularly, or dual polarized antenna may be a patch, spiral, helix, or any other elliptically, circularly, or dual polarized antenna. Recitation of elliptical includes circular, dual, and multi, and vice versa, whether specified or not. Recitation of a transmitter means an RF power transmitter, whether specified or not.

Recitation of an RF power transmitter may mean the RF power transmitter with or without an antenna, depending on usage. Additionally, the RF power transmitter and antenna may be discussed separately. Likewise, recitation of a receiver means the receiver with or without an antenna, depending on usage. Additionally, the receiver and antenna may be discussed separately.

Given an RF power transmitter, a circularly polarized antenna outputs a signal that is essentially distributed equally in the horizontal and vertical planes and all planes between. The output of a circularly polarized antenna can be described as a vector spinning around a circle with horizontal, or X-, and vertical, or Y-, axes that are equal in magnitude. There is only a finite amount of power being supplied to the antenna by the RF power transmitter, so the power available in the X-direction and the power available in the Y-direction have to add to the total amount of power being supplied to the antenna by the RF power transmitter. In circular polarization, the X- and Y-axes are equal in magnitude so each axis gets half of the power being supplied to the antenna by the RF power transmitter, and the magnitudes add to the total power being supplied to the antenna by the RF power transmitter. Because the X- and Y-axes are equal in magnitude, the antenna vector will have the same magnitude no matter which way the antenna vector points on the circle. These vectors can be seen in FIG. 1.

There are two traditional ways to implement such an antenna, right-handed polarization (RHP) and left-handed polarization (LHP). This refers to the direction in which the antenna vector or electric field vector spins around the circle defined by the X- and Y-axes as above. In RHP, the antenna vector spins in the clockwise direction from the perspective of facing in the power propagation direction. In LHP, the antenna vector spins in the counter-clockwise direction from the perspective of facing in the power propagation direction. They are opposite to one another, so an antenna set up for RHP can not receive signals from a LHP antenna, and vice versa.

A polarization that can be implemented in a similar fashion is elliptical polarization. Elliptical polarization can be described the same way as circular polarization was described above, as a vector spinning around an ellipse, except that the X- and Y-axes of the ellipse are not equal. As is obvious now, circular polarization is a special type of elliptical polarization, where the axial ratio is equal to 1. The axial ratio is a numeric expression that is used as a specification for elliptically polarized antennas and describes the ratio of the axes. The axial ratio is defined to be at least 1 with 1 being the axial ratio for a circularly polarized antenna. Because the axial ratio, by definition, cannot be less than 1, the result is taken as the axis with the larger magnitude divided by the magnitude of the other axis. This means that an axial ratio of 4 could have a magnitude of 4 units in the X-axis, but only a magnitude of 1 in the Y-axis. Or, an axial ratio of 4 could have a magnitude of 8 units in the Y-axis, but only a magnitude of 2 in the X-axis. Another parameter of the elliptically polarized antenna is the tilt angle, which is the angle with respect to the X-axis of the maximum radius of the ellipse.

As with circularly polarized antennas, the antenna vector for an elliptically polarized antenna can spin in either direction, making the antenna RHP or LHP. Also, the magnitudes of each axis in an elliptically polarized antenna add up to the total power being supplied to the antenna by the RF power transmitter. However, the magnitudes of the axes are not the same, so as the vector spins around the ellipse, more power will be available in a certain plane than in a plane that is perpendicular to that plane. This is useful for a system where it is known that the probability of a linearly polarized antenna on an RF power receiving device being in one plane is greater than the probability of that same antenna being in a perpendicular plane. Most of the power is available when the antenna is in the most probable position (plane), but if the antenna happens to not be in the most probable position (plane), the device is still able to receive power. The vectors for an elliptically polarized antenna are shown in FIG. 2.

In general, when using a circular, elliptical, or dual receiver with a circular, elliptical, or dual RF power transmitter, the polarizations of the antennas must match. That is, a LHP antenna in the RF power transmitter must be used with a LHP antenna in the receiver. The same holds for RHP antennas. An LHP antenna will not work with a RHP antenna, and vice versa.

This may not be advantageous for a power transmission system due to variations in the transmitting antenna polarization for different positions of the receiving antenna relative to the transmitting antenna location. As an example, a bi-directional circularly polarized transmitting antenna may have RHP in front (0°) and LHP in back (180°), meaning a RHP receiver antenna could only receive power in front of the transmitter antenna.

One solution to the above power problem for untethered devices is to provide an elliptical, circular, or dual polarized receiver antenna to receive RF power from a linearly polarized transmitter antenna. While this solves the problem of mismatched polarity, other issues arise.

Given a linearly polarized antenna (for example, a dipole) designed to resonate and radiate at the same frequency with the same gain as an elliptically or circularly polarized antenna (for example, a spiral), the physical area Aₚ of the linearly polarized antenna would be significantly less than the Aₚ of the elliptically, circularly, or dual polarized antenna. However, the effective area Aₑ would be the same. Thus, the overall dimensions needed to utilize the linearly polarized antenna are less than those needed to utilize the elliptically, circularly, or dual polarized antenna to achieve the same results.

Due to the configuration of an elliptically, circularly, or dual polarized antenna, the receiver would need to be of a relatively large size to accommodate the large physical size of the antenna. The RF power transmitter would be smaller since it accommodates a smaller (in physical size) linearly polarized antenna.

For example, the receiver with an antenna may be implanted in the human head to power a deep brain stimulation device. The required incision would need to accommodate the physical size of the receiver with the antenna. The larger the incision, the increase in risk of injury and infection.

For another example, the receiver with an antenna may be part of a headset for a phone. Again, the size of the device would need to accommodate the size of the receiver with the antenna.

Thus, a need exists to provide an RF power transmission system where the receiver may change polarization without destroying the purpose of the system and where the receiver is of a small size.

### BRIEF SUMMARY OF THE INVENTION

It is an object of this invention to provide an RF power transmission system where the receiver may change polarization without destroying the purpose of the system and where the receiver is of a small size (e.g., as small as possible).

A system for power transmission according to the present invention includes a receiver having a receiver antenna. An RF power transmitter includes a transmitter antenna. The RF power transmitter transmits RF power. The RF power includes multiple polarization components. The receiver converts the RF power to direct current.

An antenna for an RF power transmission system includes at least two antenna elements. Alternating the radiation between the at least two antenna elements produces a power transmission having components in two polarizations.

A preferred embodiment of the present invention is a power transmission system including an elliptically, circularly, dual, or multi polarized RF power transmitter antenna and a linearly polarized receiver antenna. In this configuration, the overall size of the receiver can be designed to be as small as possible.

A method and apparatus for high efficiency rectification for various loads, which is suitable for use with the present invention, has been discussed in detail in U.S. Provisional Patent Application No. 60/729,792, which is incorporated herein by reference.

The present invention pertains to a system for power transmission. The system comprises a transmitter for wirelessly transmitting energy. The system comprises a receiver having an energy harvester, wherein the energy harvester receives the energy, the energy harvester converts the energy into a direct current, and when the receiver is within a space defined by a radiation pattern of the transmitter, the direct current is greater than or equal to a predetermined level regardless of a polarization of the receiver with respect to the transmitted energy.

The present invention pertains to a method for power transmission. The method comprises the steps of transmitting wirelessly energy from a transmitter. There is the step of receiving the energy from the transmitter at a receiver having an energy harvester. There is the step of converting the energy received by the receiver with the energy harvester into a direct current, when the receiver is within a space defined by a radiation pattern of the transmitter, the direct current is greater than or equal to a predetermined level regardless of the polarization of the receiver with respect to the transmitted energy.

The present invention pertains to a transmitter for power transmission to a receiver having an energy harvester which receives the power transmission from the transmitter and converts the energy into direct current. The transmitter comprises a power source. The transmitter comprises at least one antenna in communication with a power source from which a radiation pattern emanates so that when the receiver is within a space defined by the radiation pattern, then the direct current from the energy harvester is greater than or equal to a predetermined level regardless of the polarization of the receiver with respect to the transmitted energy. The power source can include any source of power such as an RF power source, a battery; or an electrical power grid (AC or DC) with connection thereto, or a solar cell or combinations thereof, but not limited thereto.

The present invention pertains to a receiver which receives energy from a transmitter which transmits the energy wirelessly in a space defined by a radiation pattern of the transmitter. The receiver comprises at least one antenna which receives the wirelessly transmitted energy: The receiver comprises an energy harvester in communication with the antenna which receives the energy and converts the energy into a direct current, and when the receiver is within the space defined by the radiation pattern of the transmitter, the direct current is greater than or equal to a predetermined level regardless of a polarization of the receiver with respect to the transmitted energy.

The present invention pertains to a system for power transmission. The system comprises means for wirelessly transmitting energy. The system comprises means for receiving the wirelessly transmitted energy and converting the energy into a direct current, and when the receiving means is within a space defined by a radiation pattern of the transmitting means, the direct current is greater than or equal to a predetermined level regardless of a polarization of the receiving means with respect to the transmitted energy.

### BRIEF DESCRIPTION OF THE SEVERAL VIEWS OF THE DRAWINGS

FIG. 1 is an illustration of a circularly polarized antenna vector;

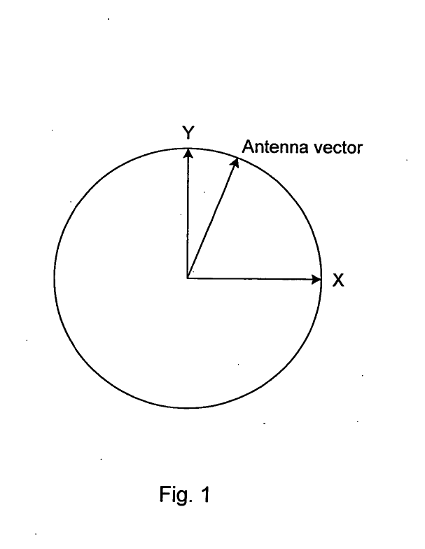

FIG. 2 is an illustration of an elliptically polarized antenna vector;

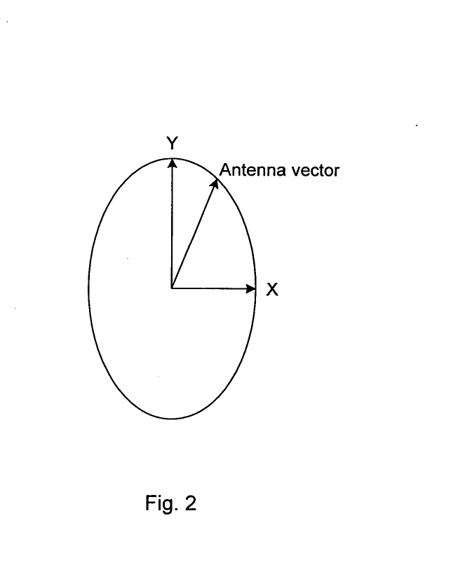

FIG. 3 is an illustration of a power transmission system according to the present invention including an RF power transmitter having a multi polarized antenna and a receiver having a linearly polarized antenna;

FIG. 4 is an illustration of a second embodiment of a power transmission system according to the present invention including an RF power transmitter having at least two linearly polarized antennas and a receiver having a linearly polarized antenna;

FIG. 5 is an illustration of a switch that may be used with the system illustrated in FIG. 4;

FIG. 6 is an illustration of output from an embodiment of the present invention utilizing the switch illustrated in FIG. 5;

FIG. 7 is an illustration of a third embodiment of a power transmission system according to the present invention including an RF power transmitter having at least three linearly polarized antennas and a receiver having a linearly polarized antenna;

FIG. 8 is an illustration of a fourth embodiment of a power transmission system according to the present invention including more than one receiver; and

FIG. 9 is an illustration of a fifth embodiment of a power distribution system according to the present invention including more than one RF power transmitter.

### DETAILED DESCRIPTION OF THE INVENTION

A complete understanding of the invention will be obtained from the following description when taken in connection with the accompanying drawing figures wherein like reference characters identify like parts throughout.

For purposes of the description hereinafter, the terms “upper”, “lower”, “right”, “left”, “vertical”, “horizontal”, “top”, “bottom”, and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

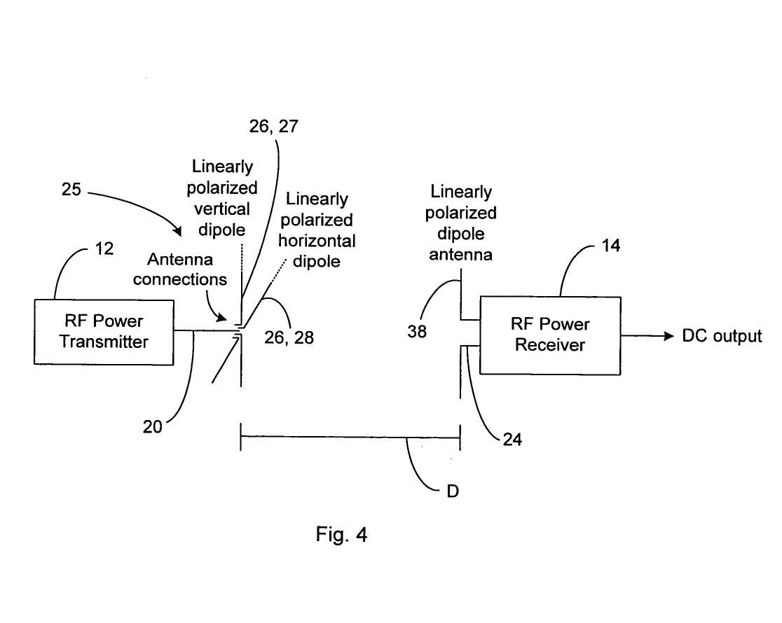

The present invention pertains to a system 10 for power transmission, as shown in FIG. 4. The system 10 comprises a receiver 14 including a receiver antenna 22. The system 10 comprises an RF power transmitter 12 including a transmitter antenna 18, wherein the RF power transmitter 12 transmits RF power, the RF power includes multiple polarization components, and the receiver 14 converts the RF power to direct current.

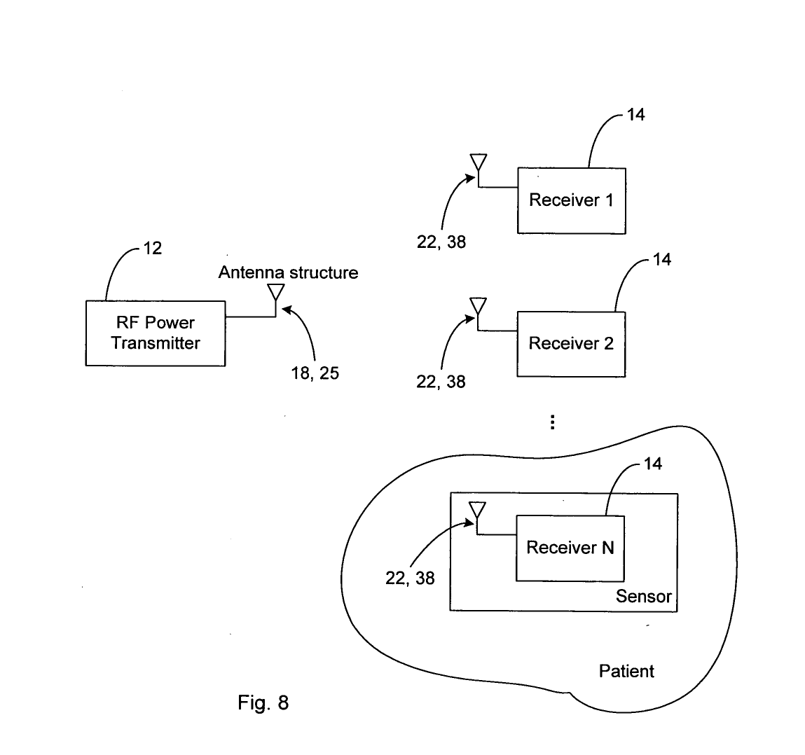

The receiver antenna 22 can be linearly polarized. The RF power does not need to include data. The RF power transmitter 12 can pulse the transmission of the RF power. The transmitter antenna 18 can include more than one antenna element. The system 10 can then include more than one receiver 14, as shown in FIG. 8. Alternatively, when the receiver 14 rotates to any angle that maintains a gain of the transmitter antenna 18 and the receiver antenna 22, system 10 performance is not compromised.

The receiver 14 can include an implantable component. Alternatively, the receiver 14 is included in a sensor. The system 10 can include more than one receiver. The RF power can be used to charge at least one power storage component. Alternatively, the RF power is used to directly power a device.

The present invention pertains to an antenna for an RF power transmission system 10, as shown in FIG. 4, comprising at least two antenna elements, wherein alternating the radiation between the at least two antenna elements produces a power transmission having components in at least two polarizations.

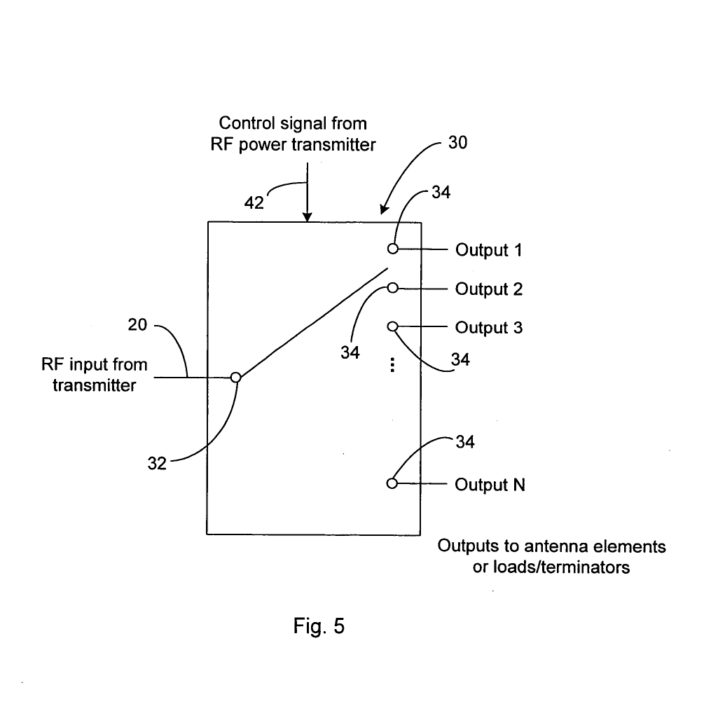

The radiation of the at least two antenna elements can produce a pulsed power transmission from the antenna. Alternatively, at least one of the at least two antenna elements can be turned on at a different time with respect to the other antenna elements. The antenna preferably includes a switch for selectively turning each antenna element on and off, as shown in FIG. 5.

Alternatively, each antenna element can be a different polarization with respect to the other antenna elements. Alternatively, the at least two antenna elements are orthogonal with respect to the other antenna elements, as shown in FIG. 4. Alternatively, each of the at least two antenna elements are linearly polarized. Alternatively, at least one of the at least two antenna elements transmits at a different frequency with respect to the other antenna elements.

The antenna can include a first linearly polarized antenna and a second linearly polarized antenna.

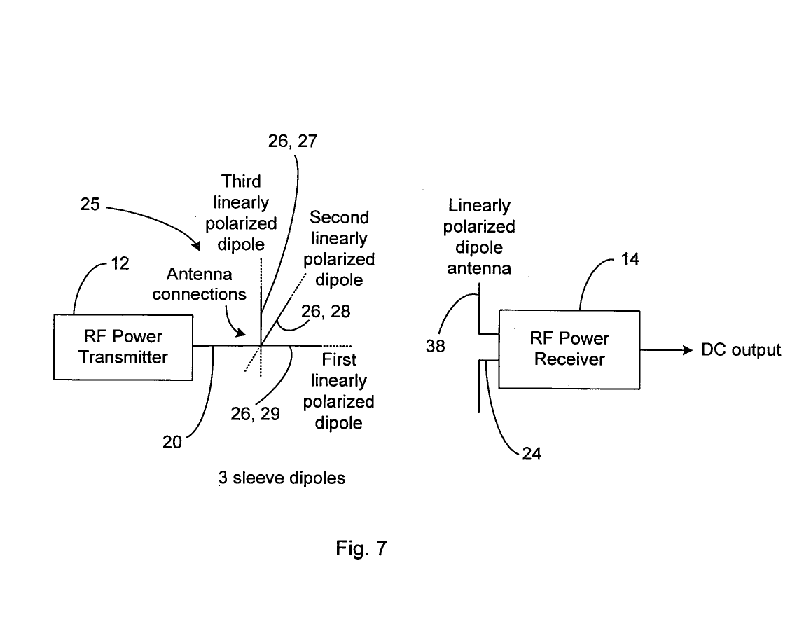

The first linearly polarized antenna can be a vertically polarized dipole antenna and the second linearly polarized antenna can be a horizontally polarized dipole antenna, as shown in FIG. 4. The antenna can include a third linearly polarized dipole antenna, as shown in FIG. 7.

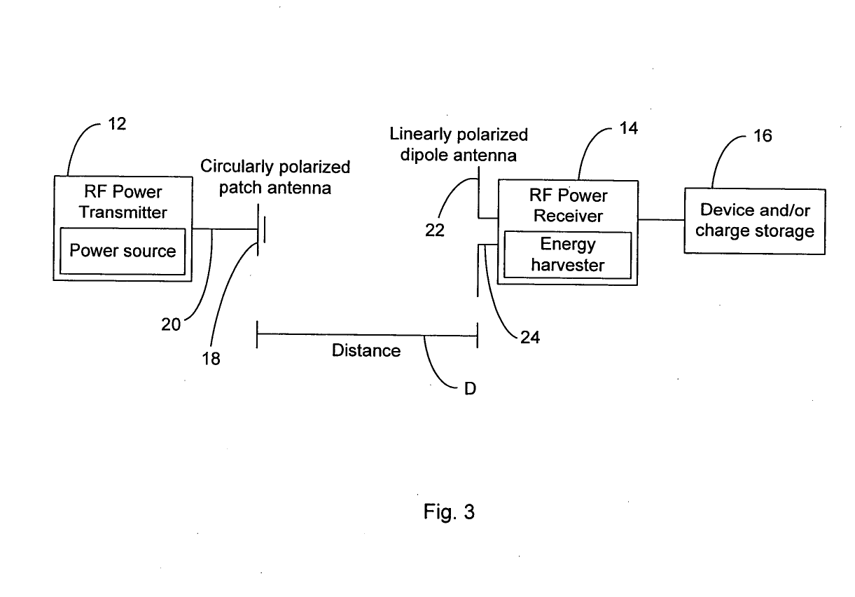

As shown in FIG. 3, the transmitter antenna 18 can be circularly polarized. The transmitter antenna 18 can be a patch antenna. The receiver antenna 22 can be a dipole antenna.

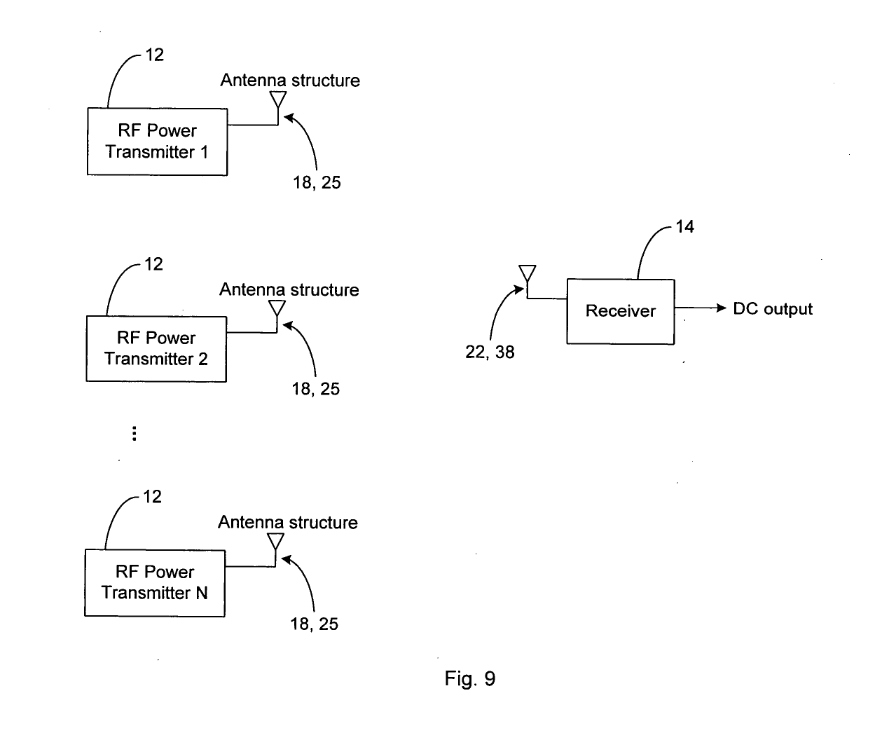

The transmitter antenna 18 can include a switch for selectively turning each internal element on and off, as shown in FIG. 5. The power transmitter 12 can provide a control signal for tuning each antenna element on and off. There can be more than one transmitter, as shown in FIG. 9.

The present invention pertains to a system 10 for power transmission. The system 10 comprises a transmitter 12 for wirelessly transmitting energy. The system 10 comprises a receiver 14 having an energy harvester, wherein the energy harvester receives the energy, the energy harvester converts the energy into a direct current, and when the receiver 14 is within a space defined by a radiation pattern of the transmitter 12. The direct current is greater than or equal to a predetermined level regardless of a polarization of the receiver with respect to the transmitted energy. Preferably, the space is defined by half power points of the radiation.

The present invention pertains to a method for power transmission. The method comprises the steps of transmitting wirelessly energy from a transmitter 12. There is the step of receiving the energy from the transmitter 12 at a receiver 14 having an energy harvester. There is the step of converting the energy received by the receiver 14 with the energy harvester into a direct current, when the receiver 14 is within a space defined by a radiation pattern of the transmitter 12, the direct current is greater than or equal to a predetermined level regardless of the polarization of the receiver 14 with respect to the transmitted energy.

The present invention pertains to a transmitter 12 for power transmission to a receiver 14 having an energy harvester which receives the power transmission from the transmitter 12 and converts the energy into direct current, as shown in FIG. 3. The transmitter 12 comprises a power source. The transmitter 12 comprises at least one antenna in communication with a power source from which a radiation pattern emanates so that when the receiver 14 is within a space defined by the radiation pattern, then the direct current from the energy harvester is greater than or equal to a predetermined level regardless of the polarization of the receiver 14 with respect to the transmitted energy. The power source can include any source of power, such as an RF power source, a battery; or an electrical power grid (AC or DC) with connection thereto, or a solar cell or combinations thereof, but not limited thereto.

The present invention pertains to a receiver 14 which receives energy from a transmitter 12 which transmits the energy wirelessly in a space defined by a radiation pattern of the transmitter 12. The receiver 14 comprises at least one antenna which receives the wirelessly transmitted energy. The receiver 14 comprises an energy harvester in communication with the antenna which receives the energy and converts the energy into a direct current, and when the receiver 14 is within the space defined by the radiation pattern of the transmitter 12, the direct current is greater than or equal to a predetermined level regardless of a polarization of the receiver 14 with respect to the transmitted energy.

The present invention pertains to a system 10 for power transmission. The system 10 comprises means for wirelessly transmitting energy. The system 10 comprises means for receiving the wirelessly transmitted energy and converting the energy into a direct current, and when the receiving means is within a space defined by a radiation pattern of the transmitting means, the direct current is greater than or equal to a predetermined level regardless of a polarization of the receiving means with respect to the transmitted energy. The transmitting means can be a transmitter 12 with at least one of the various types of antennae identified herein. The receiving means can be an energy harvester with at least one of the various types of antennae identified herein.

Referring to FIG. 3, in a first embodiment, a radio frequency (RF) power (energy) transmission system 10 according to the present invention includes an RF power transmitter 12 and a receiver 14 (harvesting device, harvester, energy harvester). The RF power transmitter 12 transmits RF power (energy). The receiver converts the RF power (energy) to direct current (DC) power in order to power (directly or indirectly) a device 16.

The RF power transmitter 12 includes an elliptically, circularly, or dual polarized antenna 18. The elliptically, circularly, or dual polarized antenna 18 may be, but is not limited to, a patch, a spiral, a helix, or any other similarly polarized antenna. The RF power transmitter 12 is connected to the elliptically, circularly, or dual polarized antenna via a coaxial cable, transmission line, waveguide, other similar suitable means, suitable connectors, or antenna connections 20. The elliptically, circularly, or dual polarized antenna 18 may be fed from the side, through a coaxial feed, etc.

The receiver 14 includes a linearly polarized antenna 22. The linearly polarized antenna 22 may be, but is not limited to, a dipole, monopole, folded dipole, patch, yagi, sleeve dipole, loop, horn, dish, corner reflector, or any other similarly polarized antenna. The linearly polarized antenna 22 may have any length, preferably a half a wavelength. The receiver 14 is connected to the linearly polarized antenna 22 via a microstrip transmission line, coaxial cable, other suitable means, suitable connectors, or antenna connections 24. The receiver 14 is also connected to the device 16 to be powered. The device may include charge storage components (e.g., a battery, a capacitor). The RF power transmitter 12 transmits an elliptically, circularly, or dual polarized wave. The wave travels in a radiation pattern. The wave travels a distance D within a space defined by the radiation pattern to the receiver. The space may be defined by half power points of the radiation transmitted or by some other reference level, such as, but not limited to, 10 dB below the maximum radiation transmitted. The configuration of the RF power transmitter 12 and the receiver 14 allows the receiver 14 to change polarization and still receive sufficient power from the RF power transmitter 12. Sufficient power is a direct current greater than or equal to a predetermined level required by the device 16. Thus, the device 16 connected to, or housing, the receiver antenna 22 may rotate to any angle that maintains the gain of the transmitter and the receiver antennas 18, 22 without compromising system 10 performance, whether the device is also moving in translation or not moving in translation.

In one example, the receiver 14 is included in a device 16 that is implanted in a body, such as a receiver 14 implanted into a head of a person to power a deep brain stimulator. The receiver 14 receives RF power from an RF power transmitter 12 external to the person. The RF power transmitter 12 may be positioned to send RF power to the receiver 14 to charge or re-charge the power storage component(s) of the device 16 or power the device 16.

If the RF power transmitter 12 is attached to the headboard, while the person is in bed, the receiver 14 is receiving the RF power from the RF power transmitter 12. As long as the person is in a position orthogonal to the headboard, the rotation of the sleeping person would not significantly influence the reception of the RF power. Thus, the person could toss and turn (i.e., roll back and forth) while still receiving a sufficient amount of RF power without loss of receiver 14 power due to changes in polarization.

If more than one RF power transmitter 12 is utilized (see also FIG. 9), where the RF power transmitters 12 are located in various different positions having the same or differing polarizations, the receiver 14 may move into more positions while still receiving sufficient power while not realizing loss of receiver 14 power due to changes in polarization. For example, an RF power transmitter 12 may be attached to a headboard of a bed, be positioned on a night table, a floor beneath the bed, or a ceiling above the bed and the person may assume other positions in the bed. Networking of RF power transmitters 12 has been discussed in detail in U.S. Provisional Patent Application Nos. 60/683,991 and 60/763,582, which are both entitled Power Transmission Network and incorporated herein by reference.

For example, if a first RF power transmitter 12 were placed on a headboard, the person may toss and turn (i.e., roll back and forth) while sleeping and receive a sufficient amount of power from the first RF power transmitter 12. If the person were to sit up, however, the receiver 14 would not receive the sufficient amount of power from the first RF power transmitter 12 due to gain loss. If a second RF power transmitter 12 were placed on the ceiling, the person may then also sit up while receiving the sufficient amount of power from the second RF power transmitter 12 while not realizing a loss of receiver 14 power due to changes in polarization with respect to the second RF power transmitter 12.

Referring to FIG. 4, in another embodiment, an RF power transmission system 10 according to the present invention includes an RF power transmitter 12 and a receiver 14 (harvesting device, harvester, energy harvester). The RF power transmitter 12 transmits RF power (energy). The receiver 14 converts RF power (energy) to direct current (DC) power in order to power (directly or indirectly) a device (not shown in FIG. 4).

The RF power transmitter 12 includes at least two linearly polarized antenna elements 26 (i.e., antenna elements 26 form one antenna structure 25). One antenna element 27 is positioned to have vertical polarization (elevation), and one antenna element 28 is positioned to have horizontal polarization (azimuth). The two linearly polarized antenna elements 26 are separated by an angle, such as an orthogonal angle. The antenna elements 26 make up the antenna structure 25 that may be a single antenna with multiple ports.

The linearly polarized antenna elements 26 may be, but are not limited to, a dipole, monopole, folded dipole, patch, yagi, sleeve dipole, loop, horn, dish, corner reflector, or any other similarly polarized antenna. In the figure, two dipoles are illustrated. The RF power transmitter 12 is connected to the antenna elements 26 via a coaxial cable, transmission line, waveguide, other suitable means, suitable connectors, or antenna connections 20. The antenna elements 26 may be fed from the side, through a coaxial feed, etc.

The RF power transmitter 12 transmits a wave(s) that travels a distance D to the receiver 14. Since the RF power transmitter 12 transmits power from each antenna element 26 and each antenna element 26 is in a different polarization, the power transmitted has multiple polarization components. The transmission from the RF power transmitter 12 may be a continuous wave (CW) or a pulsed wave (PW).

For a continuous wave, a splitter may be incorporated. The splitter introduces a phase shift between signals supplied to the antenna elements 26, preferably, a phase shift of 90°. The continuous wave RF power transmission system 10 produces a power transmission that is elliptical, circular, or dual polarized, that is, it has simultaneous components in two polarizations.

The receiver 14 includes an antenna 38, preferably a linearly polarized antenna. The linearly polarized antenna 38 may be, but is not limited to, a dipole, monopole, folded dipole, patch, yagi, sleeve dipole, loop, horn, dish, corner reflector, or any other similarly polarized antenna. The linearly polarized antenna 38 may have any length, preferably a half a wavelength. The receiver 14 is connected to the linearly polarized antenna 38 via a microstrip transmission line, coaxial cable, or other suitable means, suitable connectors, or antenna connectors 24. The receiver 14 is also connected to a device to be powered. The device may include charge storage components (e.g., a battery, a capacitor).

A pulsing RF power transmitter has been described in detail in U.S. Nonprovisional patent application Ser. No. 11/356,892 and U.S. Provisional Patent Application No. 60/758,018, which are both entitled Pulsing Transmission Method and incorporated herein by reference.

The pulsing wave RF power transmission system 10 produces a power transmission that over time (i.e., one pulsing period of the RF power transmitter) looks and acts like a transmission from an elliptically, circularly, or dual polarized antenna, that is, it has components in two polarizations over time. This transmission has numerous advantages over a typical elliptically or circularly polarized antenna.

The RF transmitter 12 becomes a multi-polarized pulsing transmitter (MPPT). The MPPT transmits a dual polarized wave. The wave travels in a radiation pattern. The wave travels a distance D within a space defined by the radiation pattern to the receiver antenna 38. The space may be defined by half power points of the radiation. The configuration of the RF power transmitter 12 and the receiver 14 allows the receiver 14 to change polarization with respect to the RF power transmitter 12 and still receive sufficient power from the RF power transmitter 12. Sufficient power is a direct current greater than or equal to a predetermined level required by the device 16. In other words, a device 16 housing the receiver antenna 38 may rotate to any angle that maintains the gain of the transmitter and the receiver antennas 25, 38 without compromising system 10 performance.

The RF power may be alternated or pulsed between the antenna elements 26. The two or more linearly polarized antenna elements 26 may transmit at different frequencies. The same antenna design may be used for each antenna element 26, depending on the frequencies of each antenna element 26. Antenna elements 26 may be different types of antennas, for example, a dipole and a patch. The frequencies are preferably spaced ≧20 kHz apart.

As illustrated in FIG. 5, a switch 30 may be used to selectively turn each antenna element 26 on and off to achieve the alternation or pulsing.

The switch 30 may be, but is not limited to, electromechanical or solid state, such as a relay or PIN diode, respectively. The RF power transmitter 12 is connected to the switch via coaxial cable, transmission line, waveguide, or other suitable means and suitable connectors 20. The input 32 of the switch 30 is connected to the RF power transmitter 12 and receives the RF power. The outputs 34 of the switch 30 are connected to the antenna elements 26, which in turn receive the RF power. One or more outputs 34 may be a terminating load. Thus, the switch 30 may have 1 input 32 to N outputs 34, as illustrated in the figure. It should be noted that the outputs of the switch which are not active may be open circuited, short circuited, or may be connected to a load to ensure that the unactive antenna element(s) do not significantly influence the radiation from the active antenna element(s).

The RF power transmitter 12 controls the switch 30 using a control signal 42 from a controller. The controller may be in the RF power transmitter 12. The controller may be a microprocessor, a timer, a computer, or a user control.

The axial ratio of the MPPT can be set via the controller by adjusting the duty cycle of each antenna element 26, that is, how long each antenna element 26 is on with respect to the other antenna element 26. For example, the antenna element 27 with vertical polarization may be used for 75% of the total power, and the antenna element 28 with horizontal polarization may be used for the other 25% of the total power. It should be noted that there may be periods of no power transmission, that is, periods when the power is delivered to the terminating load or when the RF power transmitter 12 is not active, such that no antenna element 26 receives power, for example, during pulsing. It should be noted that time periods do not have to be equal. Also, the amplitude of the frequencies transmitted from each antenna element 26 may be different, that is, the input power from the RF power transmitter 12 may change with time.

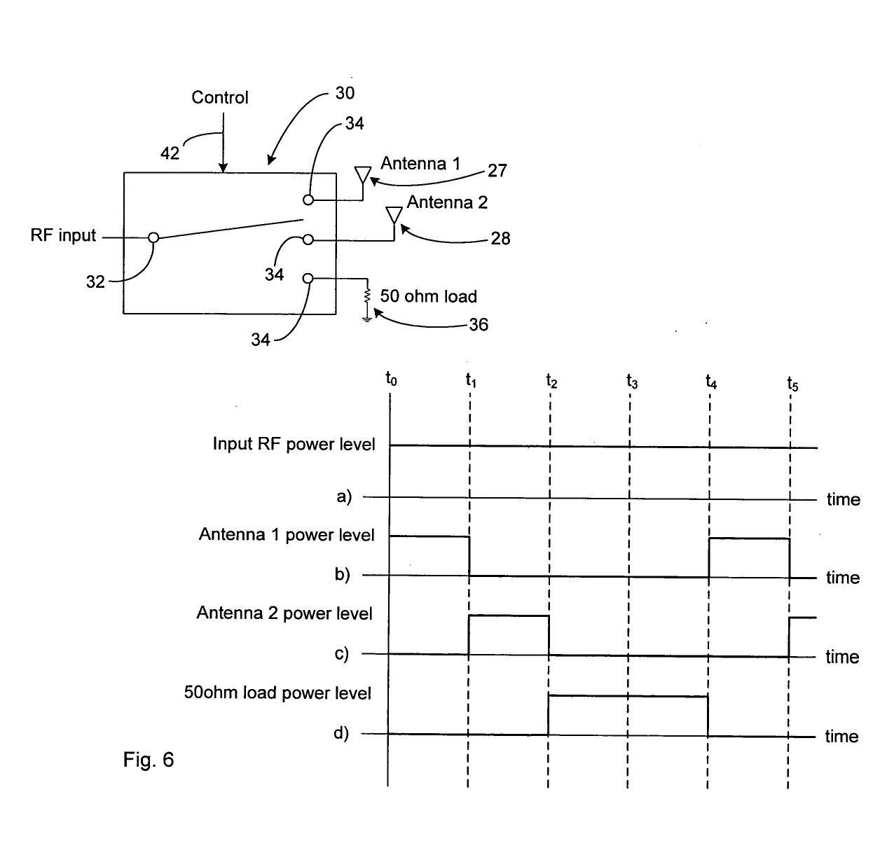

FIG. 6 illustrates an example of output generated when a switch 30 is used according to the present invention. In this example, a single input 32, three output 34 switch 30 is used. Two of the outputs 34 are connected to two antenna elements 27, 28 (antenna 1 and antenna 2, respectively). The third output 34 is connected to a 50 ohm load 36.

Graph a) shows the input power level as constant over time. Graph b) shows the power level to antenna element 27 (antenna 1) as being on for a first time period t₁-t₀, being off for a second time period t₂-t₁, being off for a third time period t₃-t₂, being off for a fourth time period t₄-t₃, and being on for a fifth time period t₅-t₄. Graph c) shows the power level to antenna element 28 (antenna 2) as being off for the first time period, on for the second time period, off for the third time period, off for the fourth time period, and off for the fifth time period. Graph d) shows the power level to the 50 ohm load 36 as being off for the first time period, off for the second time period, on for the third time period, on for the fourth time period, and off for the fifth time period.

In other words, for the first time period, power is delivered to antenna element 27 (antenna 1). For the second time period, power is delivered to antenna element 28 (antenna 2). For the third and fourth time periods, power is delivered to the load 36. For the fifth time period, the sequence starts to repeat. Thus, there is a pulsing waveform out of antenna element 27 (antenna 1), for example, vertically polarized. There is another pulsing waveform out of antenna element 28 (antenna 2), for example, horizontally polarized. When the power is delivered to the load 36, this effectively results with no power being transmitted from the RF power transmitter 12.

The receiver antenna 38 for use in the MPPT may be a linearly or a circularly/elliptically/dual antenna. An elliptically, circularly, or dual polarized antenna 38 may be, but is not limited to, a patch, a spiral, a helix, or any other similarly polarized antenna.

In general, when using a circular, elliptical, or dual receiver with a circular, elliptical, or dual RF power transmitter, the polarizations of the antennas must match. That is, a LHP antenna in the RF power transmitter must be used with a LHP antenna in the receiver. The same holds for RHP antennas. An LHP antenna will not work with a RHP antenna, and vice versa.

Thus, if a circular receiver antenna 38 is used with the MPPT, whether the RF power transmission is LHP or RHP is irrelevant. This is because the RF power transmission from the RF power transmitter 12 is not elliptically or circularly polarized in the traditional sense, but does contain polarization components in multiple planes.

In general, a circularly polarized transmitter will supply an equal amount of power to a linearly polarized antenna in all polarizations. A goal of the type of system 10 according to the present invention is to eliminate the polarization loss factor (PLF) term. However, there is a 3 dB loss in gain due to the fact that the linearly polarized antenna can only capture a single component of the dual component circularly polarized wave (or a combination of each which equals a single vector).

As an example, a circularly polarized wave traveling in the direction of the y-axis (θ=90°,φ=90°) can be represented by the following polarization vector.

$${\hat{p}}_{1} = \frac{{\hat{a}}_{θ} + j {\hat{a}}_{ϕ}}{\sqrt{2}} = \frac{- {\hat{a}}_{x} - j {\hat{a}}_{x}}{\sqrt{2}}$$

If a wave impinges on a linear polarized antenna with a polarization vector in the z-direction, the resulting PLF will be 0.5 or a 3 dB loss.

$${\hat{p}}_{2} = {\hat{a}}_{x}$$

$${\vert {\hat{p}}_{1} \cdot {\hat{p}}_{2} \vert}^{2} = {\vert ( \frac{- {\hat{a}}_{x} - j {\hat{a}}_{x}}{\sqrt{2}} ) \cdot {\hat{a}}_{x} \vert}^{2} = {\vert \frac{- 1}{\sqrt{2}} \vert}^{2} = 0.5$$

The preceding analysis makes the assumption that the polarization is constant over the entire pattern although it is very difficult to design an antenna that maintains a constant polarization state.

Discussed in Antenna Theory Analysis and Design, by Constatine A. Balanis (pp. 64 and 876), polarization of the energy radiated from an antenna varies with the direction from the center of the antenna. Thus, different parts of the pattern may have different polarizations. For this reason, the polarization of an antenna is best displayed on the surface of a Poincaré sphere. Analysis shows that maintaining the same polarization state in all parts of the pattern of an antenna is difficult. Thus, for a circularly polarized antenna, the polarization state will not be circular in all parts of the pattern—some parts will be elliptical, some will be linear.

Referring to FIG. 7, another embodiment of the present invention is a variation of the MPPT. An RF power transmission system 10 includes an RF power transmitter 12 and a receiver 14 (harvesting device, harvester, energy harvester). The RF power transmitter 12 transmits RF power (energy). The receiver 14 converts RF power (energy) to direct current (DC) power in order to power (directly or indirectly) a device (not shown in FIG. 7).

In this embodiment, the RF power transmitter antenna structure 25 includes three antenna elements 26, preferably, positioned orthogonal with respect to each other (e.g., a tri-crossed dipole). The antenna elements 26 may be end fed or center fed, such that they overlap each other or meet at their ends (e.g., orthogonal sleeve dipoles).

The linearly polarized antenna elements 26 may be, but are not limited to, a dipole, monopole, folded dipole, patch, yagi, sleeve dipole, loop, horn, dish, corner reflector, or any other similarly polarized antenna. In the figure, three dipoles are illustrated. The antenna elements 26 may be three different antennas, such as a dipole, a patch, and a yagi. The RF power transmitter 12 is connected to the antenna elements 26 via a coaxial cable, transmission line, waveguide, other suitable means, suitable connectors, or antenna connections 20.

An antenna 38 having any type (linear or elliptical/circular/dual) of polarization may be used in the receiver 14 in this embodiment.

A linearly polarized antenna 38 may be, but is not limited to, a dipole, monopole, folded dipole, patch, yagi, sleeve dipole, loop, horn, dish, corner reflector, or any other similarly polarized antenna. The linearly polarized antenna 38 may have any length, preferably a half a wavelength. The receiver 14 is connected to the linearly polarized antenna 38 via a microstrip transmission line, coaxial cable, other suitable means, suitable connectors, or antenna connections 24.

An elliptically, circularly, or dual polarized antenna 38 may be, but is not limited to, a patch, a spiral, a helix, or any other similarly polarized antenna. The RF power transmitter 12 is connected to the elliptically, circularly, or dual polarized antenna via a coaxial cable, transmission line, waveguide, other suitable means, suitable connectors, or antenna connections 24. The elliptically, circularly, or dual polarized antenna 38 may be fed from the side, through a coaxial feed, etc.

The receiver 14 is also connected to a device to be powered. The device may include charge storage components (e.g., a battery, a capacitor).

The RF power is alternated or pulsed between the three antenna elements 26, similar to above. Again, this effectively creates a power transmission that looks and acts like a transmission from an elliptically or circularly polarized antenna over time.

In this configuration, the gain loss is less than a two antenna element (27 and 28 only) MPPT. For example, in FIG. 7, two antenna elements 28, 29 are positioned to have horizontal polarization and one antenna element 27 is positioned to have vertical polarization. If a linearly polarized antenna 38 of the receiver 14 is positioned such that it is not receiving power from antenna element 27, it is capable of receiving power from antenna elements 28 and 29. Similarly, if the receiver 14 is not receiving power from antenna element 28, it is capable of receiving power from antenna elements 27 and 29. Similarly, if the receiver 14 is not receiving power from antenna element 29, it is capable of receiving power from antenna elements 27 and 28. Thus, the position of the receiver 14 does not impact the reception of the desired power. The transmission from the three antenna elements 27, 28, 29 result in no antenna nulls averaged over time.

The three antenna element 27, 28, 29 embodiment also achieves a more constant polarization over the pattern. The polarizations are elliptical (multi-polarized with unequal vector components) everywhere in the pattern, and, more importantly, near circular (multi-polarized with equal vector components) everywhere. The antenna 25 produces a near isotropic radiation pattern. These statements hold for a pattern created over time after all antenna elements 26 have been illuminated.

The power density at all points around the transmitter antenna 25 for a given distance will be nearly constant with nearly constant power in all polarizations.

The above assumes that one antenna element 26 is active at any given time. It is possible to activate more than one antenna element 26 at a time. For example, two orthogonal antenna elements 26 may be activated during the same time period, where each antenna element 26 transmits a wave 90° out of phase with the respect to the other (for example, by incorporating one or more splitters). With three antenna elements 27, 28, 29, each pair of orthogonal antenna elements 26 may be alternatingly activated. For example, in a first time period, antenna elements 27 and 28 are activated. In a second time period, antenna elements 28 and 29 are activated. In a third time period, antenna elements 29 and 27 are activated. It should be noted that the phase shift of one antenna element 26 with respect to the other may change between time periods in order to change the sense of rotation of the wave (LHP, RHP).

It should be noted that each antenna element may transmit a different frequency sequentially or simultaneously. Preferably, the frequencies are ≧20 kHz apart. The receiver could be designed to capture a band of frequencies including those transmitted. It should be noted that this configuration (multi-frequency) allows all antennas to be active at the same time without interfering with one another.

Referring generally to FIGS. 4, 7, and 8, in another embodiment, an RF power transmitter 12 including any of the above antenna configurations 18, 25 is provided to power more than one receiver 14 with any of the above configurations. Thus, a single RF power transmitter 12 could be used to power/charge more than one receiver 14.

As illustrated in FIG. 8, one RF power transmitter 12 is used to power 1 to N receivers 14. For another example, given the embodiments illustrated in FIGS. 4 and 7, a receiver 14 may be associated with each antenna element 26. The embodiment illustrated in FIG. 4 would include two receivers 14: a first receiver 14 associated with antenna element 27 and a second receiver 14 associated with antenna element 28. The embodiment illustrated in FIG. 7 would include three receivers 14: a first receiver 14 associated with antenna element 27, a second receiver 14 associated with antenna element 28, and a third receiver 14 associated with antenna element 29. The multiple DC outputs are preferably combined together.

Referring to FIG. 9, in another embodiment, more than one RF power transmitter 12 including any of the above antenna configurations 18, 25 is provided to transmit the RF power to a receiver 14 with any of the above configurations. Thus, a single receiver 14 may be charged/powered by more than one RF power transmitter 12.

The RF power transmitters 12 may be positioned to create a coverage area where there are little or no dead spots or where there are intentional dead spots. The networking of RF power transmitters has been discussed in detail in U.S. Provisional Patent Application Nos. 60/683,991 and 60/763,582, which are both entitled Power Transmission Network and have been incorporated by reference.

In any embodiment of the present invention, the RF power transmitted may be limited to include power only, that is, data is not present in the powering signal. If data is required by the application (device 16), the data is transmitted in a separate band and/or has a separate receiver 14.

In any embodiment of the present invention, the RF power transmitted may be used to directly power the device 16. The RF power transmitted may be used to charge and/or re-charge a charge storage component or components.

Any embodiment of the present invention may be incorporated into a device 16 to be charged or powered, such as, but not limited to, a sensor, an implantable component, and a personal communications device.

The invention should not be confused with power transfer by inductive coupling, which requires the device to be relatively close to the power transmission source. The RFID Handbook by the author Klaus Finkenzeller defines the inductive coupling region as distance between the transmitter and receiver of less than 0.16 times lambda where lambda is the wavelength of the RF wave. The invention can be implemented in the near-field (sometimes referred to as inductive) region as well as the far-field region. The far-field region is distances greater than 0.16 times lambda.

It will be understood by those skilled in the art that while the foregoing description sets forth in detail preferred embodiments of the present invention, modifications, additions, and changes might be made thereto without departing from the spirit and scope of the invention.

The invention claimed is:

1. A system for power transmission, comprising:
a receiver including a receiver antenna; and
an RF power transmitter including a transmitter antenna,
wherein the RF power transmitter transmits RF power,
the RF power includes multiple polarization components, and
the receiver converts the RF power to direct current.

2. The system according to claim 1, wherein the receiver is linearly polarized.

3. The system according to claim 1, wherein the RF power does not include data.

4. The system according to claim 1, wherein the RF power transmitter pulses the transmission of the RF power.

5. The system according to claim 1, wherein the transmitter antenna includes more than one antenna element.

6. The system according to claim 5, further comprising more than one receiver.

7. The system according to claim 5, wherein when the receiver rotates to any angle that maintains a gain of the transmitter antenna and the receiver antenna, system performance is not compromised.

8. The system according to claim 1, wherein the receiver is included in an implantable component.

9. The system according to claim 1, wherein the receiver is included in a sensor.

10. The system according to claim 1, further comprising more than one receiver.

11. The system according to claim 1, wherein the RF power is used to charge at least one power storage component.

12. The system according to claim 1, wherein the RF power is used to directly power a device.

13. An antenna for an RF power transmission system, comprising at least two antenna elements, wherein alternating the radiation between the at least two antenna elements produces a power transmission having components in at least two polarizations.

14. The antenna according to claim 13, wherein radiation of the at least two antenna elements produces a pulsed power transmission from the antenna.

15. The antenna according to claim 13, wherein at least one of the at least two antenna elements is turned on at a different time with respect to the other antenna elements.

16. The antenna according to claim 15, further including a switch for selectively turning each antenna element on and off.

17. The antenna according to claim 13, wherein each antenna element is in a different polarization with respect to the other antenna elements.

18. The antenna according to claim 13, wherein the at least two antenna element are orthogonal with respect to the other antenna elements.

19. The antenna according to claim 13, wherein each of the at least two antenna elements are linearly polarized.

20. The antenna according to claim 13, wherein at least one of the at least two antenna elements transmits at a different frequency with respect to the other antenna elements.

21. A system for power transmission, comprising:
a transmitter for wirelessly transmitting energy; and
a receiver having an energy harvester,
wherein the energy harvester receives the energy,
the energy harvester converts the energy into a direct current, and
when the receiver is within a space defined by a radiation pattern of the transmitter, the direct current is greater than or equal to a predetermined level regardless of a polarization of the receiver with respect to the transmitted energy.

22. The system according to claim 21, wherein the space is defined by half power points of the radiation.

23. A method for power transmission comprising the steps of:
transmitting wirelessly energy from a transmitter;
receiving the energy from the transmitter at a receiver having an energy harvester; and
converting the energy received by the receiver with the energy harvester into a direct current, when the receiver is within a space defined by a radiation pattern of the transmitter, the direct current is greater than or equal to a predetermined level regardless of the polarization of the receiver with respect to the transmitted energy.

24. A transmitter for power transmission to a receiver having an energy harvester which receives the power transmission from the transmitter and converts the energy into direct current comprising:
a power source; and
at least one antenna in communication with a power source from which a radiation pattern emanates so that when the receiver is within a space defined by the radiation pattern, then the direct current from the energy harvester is greater than or equal to a predetermined level regardless of the polarization of the receiver with respect to the transmitted energy.

25. A receiver which receives energy from a transmitter which transmits the energy wirelessly in a space defined by a radiation pattern of the transmitter comprising:
at least one antenna which receives the wirelessly transmitted energy:
and an energy harvester in communication with the antenna which receives the energy and converts the energy into a direct current, and when the receiver is within the space defined by the radiation pattern of the transmitter, the direct current is greater than or equal to a predetermined level regardless of a polarization of the receiver with respect to the transmitted energy.

26. A system for power transmission, comprising:
means for wirelessly transmitting energy; and
means for receiving the wirelessly transmitted energy and converting the energy into a direct current, and when the receiving means is within a space defined by a radiation pattern of the transmitting means, the direct current is greater than or equal to a predetermined level regardless of a polarization of the receiving means with respect to the transmitted energy.

27. A system as described in claim 5 wherein the antenna includes a first linearly polarized antenna and a second linearly polarized antenna.

28. A system as described in claim 16 wherein the first linearly polarized antenna is a vertically polarized dipole antenna and the second linearly polarized antenna is a horizontally polarized dipole antenna.

29. A system as described in claim 28 wherein the antenna includes a third linearly polarized dipole antenna.

30. A system as described in claim 2 wherein the transmitter antenna is circularly polarized.

31. A system as described in claim 30 wherein the transmitter antenna is a patch antenna.

32. A system as described in claim 31 wherein the receiver antenna is a dipole antenna.

33. A system as described in claim 5 wherein the transmitter antenna includes a switch for selectively turning each internal element on and off.

34. A system as described in claim 33 wherein the power transmitter provides a control signal for tuning each antenna element on and off.

35. A system as described in claim 34 comprising more than one transmitter.
